(19) United States
(12) Patent Application Publication
(10) Pub. No.: US 2003/0163627 A1
(43) Pub. Date: Aug. 28, 2003

(54) Enhanced universal serial bus (USB) bus monitor controller

(76) Inventors: Brian Tse Deng, Richardson, TX (US); Fengchun Duan, Coppell, TX (US); Feng Jen Wu, McKinney, TX (US)

Correspondence Address: TEXAS INSTRUMENTS INCORPORATED, P O BOX 655474, M/S 3999, DALLAS, TX, 75265

(21) Appl. No.: 10/085,413

(22) Filed: Feb. 28, 2002

(51) Int. Cl. G06F 13/14

(52) U.S. Cl. 710/305

(57) ABSTRACT

As communications busses become more generic, the handshaking that occurs to provide communications become more complicated. The constant checking of signal lines for a stable and debounced signal can consume a considerable amount of overhead and greatly increase the complexity of the design of the hardware. An independent debouncing circuit 505 and 600 can be used to detect the presence of a stable and debounced signal and notify an interface engine 320. A state machine 800 executing in the interface engine 320 uses the stable and debounced signals to control operation of a peripheral connected to the bus by monitoring signals passed on the bus.

### FIELD OF THE INVENTION

This invention relates generally to microcomputers, and particularly to controlling connectivity between peripheral devices and a universal serial bus (USB).

### BACKGROUND OF THE INVENTION

In early iterations of computers, dedicated connections were provided to connect peripheral devices to the computers. It was normal to have a separate and different connection for each type of peripheral. For example, in the microcomputer world, printing devices were usually connected to computers via a parallel interface while communications devices such as modems were connected via a serial interface. Other peripheral devices also commonly used their own unique connection with unique cabling and interface specifications. Often the connections were proprietary and used by only the one peripheral manufacturer. Dedicated connections were simple to build and to make operational. However, the wide array of connectors and connections led to a lot of confusion and unnecessary expense.

It has only been recently that computer vendors have begun to standardize on connection interfaces to reduce cost and confusion. For example, a high-speed interconnect commonly referred to as IEEE 1394 (or FireWire) is often used for connecting digital camcorders, re-writable cd-rom drives, portable hard drives, etc. to computers, while a low-speed interconnect known as the universal serial bus (USB) has been used to connect digital scanners, keyboards, mice, etc. to the same computer. The sharing of connections have eased confusion for users and simplified manufacturing for the computer vendors.

The universal serial bus (USB) has become a ubiquitous part of every modern personal computer, with practically every new computer featuring at least one USB connector. The USB allows users to connect a wide variety of devices to the personal computer, have the computer automatically detect the presence of the newly connected device, and automatically install any needed software drivers to enable full functionality of the device. The inherent flexibility of the USB has greatly sped its acceptance among consumers and manufacturers alike.

Unfortunately, the USB's ability to connect a large variety of different peripherals (its inherent flexibility), many of which vary considerably in terms of processing power, processing requirements, and communications speeds, has greatly increased the complexity of the communications between the computer, the peripheral, and the connection monitor. A great deal of communications is required between the computer, peripheral, and connection monitor in order to negotiate a connection speed, connection functionality, and to wakeup and suspend peripherals, etc.

The difficulties are exacerbated due to glitches and signal fluctuations on control and signal lines due to the insertion and removal of cables to and from the connectors. The glitches and fluctuations arise from the conductive portion of the cables sliding across the connector and intermittently making and breaking connections. The glitches and fluctuations can also arise from the pressing of buttons and keys. The glitches and fluctuations are otherwise known as signal bounce. The signals must be debounced to allow proper detection of the signals and ensure correct function of the USB. Signal debouncing requires debouncing logic to be added to the connection monitor. The additional debouncing logic can greatly increase the complexity of the design of the connection monitor. Increased complexity leads to increased design and implementation costs, which are not conducive to producing products at competitive price points.

A commonly used technique for debouncing signal lines involves the periodic checking of the states of each signal line. Once the signal value on the signal line stabilizes, the signal value on the signal line is considered stable and can be used. However, the periodic checking must be frequent enough to ensure that short-lived signal state changes are captured. The high checking frequency places a great burden on the hardware. Additionally, the incorporation of the debouncing logic control into the control hardware can greatly increase the complexity of the control hardware.

A need has therefore arisen for a method to simplify the control of connection negotiation, peripheral wake-up, and peripheral suspend between peripherals and the computer to which they are connected while providing full signal line debouncing.

### SUMMARY OF THE INVENTION

In one aspect, the present invention provides a method for monitoring signal changes on a bus interconnect comprising the steps of enabling a signal line debouncing circuit, detecting the assertion of a signal change line, decoding a debounced signal line, and performing an operation associated with a signal on the debounced signal line.

In another aspect, the present invention provides a signal debouncing circuit comprising a memory device coupled to a signal line, the memory device to store a value based on a signal value on the signal line, a serially connected sequence of storage devices coupled to the memory device, wherein: an input of a first storage device is coupled to the memory device, an input of subsequent storage devices is selectively coupled to an output of a previous storage device, and an output of a last storage device provides a debounced version of the signal value provided to the memory device.

The present invention provides a number of advantages. For example, use of a preferred embodiment of the present invention permits the full debouncing of signal lines and line states without requiring the constant monitoring of the signal lines themselves. A fully independent signal line debouncing logic circuit performs the signal debouncing and asserts a signal debounce signal line after the signals are debounced. The assertion of the debounce signal line notifies the connection (bus) monitor that there is a stable signal on the signal lines.

Also, use of a preferred embodiment of the present invention reduces the complexity of the design of the bus monitor, wherein the design of the bus monitor does not need to consider the stability of the signal lines. The bus monitor is only required to consider the actual signals on the signal lines and their function.

Additionally, use of a preferred embodiment of the present invention allows the use of a generically designed signal debounce logic in a plurality of different applications, negating the need to redesign a different signal debounce logic circuit for different applications. The same signal debounce logic can be used repeatedly in other applications, saving time and money.

### BRIEF DESCRIPTION OF THE DRAWINGS

The above features of the present invention will be more clearly understood from consideration of the following descriptions in connection with accompanying drawings in which:

FIGS. 1a and 1b illustrate a personal computer connected to several peripheral devices using a general purpose peripheral interconnect;

FIG. 2 illustrates a timing diagram of the effects of a connection being made between a cable and a connector;

FIG. 3 illustrates a universal serial bus (USB) version 2.0 peripheral according to a preferred embodiment of the present invention;

FIG. 4 illustrates a set of interface signals between a USB transceiver macrocell and a parallel interface engine (PIE) according to a preferred embodiment of the present invention;

FIGS. 5a and 5b illustrate a detailed view of a debouncing logic circuit and a storage circuit for storing states on signal lines according to a preferred embodiment of the present invention;

FIGS. 6a and 6b illustrate a detailed view of a debouncing logic circuit and a remote wakeup circuit containing a plurality of debouncing logic circuits according to a preferred embodiment of the present invention;

FIGS. 7a and 7b illustrate algorithms for processing signal state changes in a communications bus and user activated signal lines according to a preferred embodiment of the present invention; and

FIGS. 8a and 8b illustrate a bus monitor and remote wakeup unit state machine according to a preferred embodiment of the present invention.

### DETAILED DESCRIPTION OF ILLUSTRATIVE EMBODIMENTS

The making and use of the various embodiments are discussed below in detail. However, it should be appreciated that the present invention provides many applicable inventive concepts, which can be embodied in a wide variety of specific contexts. The specific embodiments discussed are merely illustrative of specific ways to make and use the invention, and do not limit the scope of the invention.

The present invention is described herein may be a portion of a peripheral that connects to a personal computer via a universal serial bus (USB) version 2.0 connection. USB version 2.0 is described in a technical specification, “Universal Serial Bus Specification, Revision 2.0, Apr. 27, 2000”, which is incorporated herein by reference. Another technical specification specifying the exchange of information in USB version 2.0, “USB 2.0 Transceiver Macrocell Interface (UTM) Specification, version 1.05, Mar. 29, 2001”, which is also incorporated herein by reference. While the specifications discuss an embodiment of the present invention that implements the USB version 2.0 specifications, the present invention is not limited solely in its applicability to USB version 2.0 based peripheral devices. The present invention has applicability to other shared bus communications systems where the peripheral devices can be connected or disconnected while the personal computer is powered on, such as IEEE 1394 (FireWire), small computer system interface (SCSI), PC Card, compact flash and smart media cards, and proprietary interconnect systems, therefore should not be construed as being so limited.

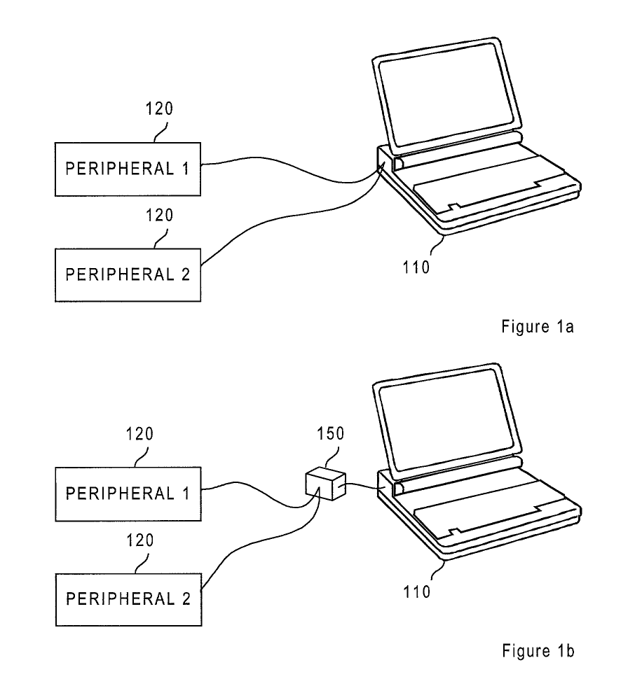

Referring now to FIGS. 1a and 1b, diagrams illustrate a personal computer 110 connected to a plurality of peripheral devices 120 using a general purpose interconnect. As discussed previously, in the early stages of personal computer development, each peripheral device would have likely been connected to a personal computer via its own unique and perhaps, proprietary interface. Recently, developers have created universal connections, such as the universal serial bus (USB), that permits the connection of a wide variety of differing types of peripherals to a personal computer using a common connector. The terms computer and personal computer will be used interchangeably in these specifications without loss of any generality or placing any limitations on the present invention.

The peripherals 120 may be connected directly to the personal computer 110 via a wired connection (as shown in FIG. 1a) or through a connection box 150, sometimes referred to as a hub, (as shown in FIG. 1b) or through some form of wireless connection (not shown) replacing the wires displayed in FIGS. 1a and b. Regardless of the connectivity (wired or wireless), the universal connector has spawned a huge array of peripherals that connect to the personal computer via the universal connection.

Unfortunately, the heretofore-unprecedented flexibility provided by these universal connections present problems of their own. The flexibility requires complex handshaking and negotiations in order to establish connections between the peripherals and the personal computer. The added ability of connecting and disconnecting peripherals while the personal computer to which they are connected also presents additional difficulties to the establishment of connections. Additionally, to save power, many of these peripherals can automatically (or via command) enter a suspend mode where minimal power is consumed. Whenever peripherals are connected, disconnected, or when buttons and keys are pressed, glitches and fluctuations can be seen on the connections.

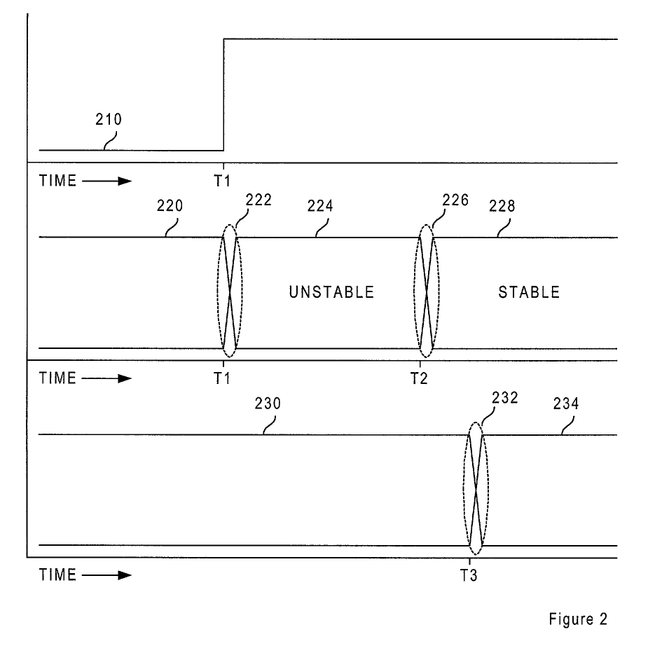

Referring now to FIG. 2, a timing diagram displays the effects of a cable being connected to a connection on the signal being carried on the connection and an output of a debouncing circuit eliminating the signal glitches and fluctuations. A first curve 210 displays the cable being connected to the connection at time T1, with a transition from a low value to a high value representing the connection of the cable. Notice that the first curve 210 could also represent a number of other activities, such as, the disconnection of a cable from the connector or the pressing of a button or key connected to the connector. A second curve 220 displays the signal being carried on the connection and a third curve 230 displays the output of the debouncing circuit.

When the cable is connected at time T1, a change is reflected on the signal value being carried on the connection. This is displayed in the second curve by a transition 222 and then a period of instability 224. Once the cable is fully connected to the connector, the instability ends (at a time T2) with another transition 226 and the signal on the connector becomes stable (displayed as a period 228).

The purpose of the debouncing circuit is to prevent signals with glitches and fluctuations from progressing into a circuit and cause erroneous actions to take place. The output of the debouncing circuit is displayed as the third curve 230. In a time prior to the attachment of the cable to the connector, the signal on the connector is stable and the output of the debouncing circuit matches the signal carried on the connector. After the cable is attached to the connector, the signal on the connector begins to fluctuate. However, the output of the debouncing circuit (third curve 230) does not fluctuate and maintains the previous signal value of the connector. Once the signal on the connector becomes stable (at time T2) and remains stable for a specified amount of time (at time T3), the output of the debouncing circuit changes (a transition 232 and a period 234) to match the value carried on the connector.

It is therefore evident that the function of a debouncing circuit is crucial to the proper operation of the universal connector and the personal computer and any peripheral devices connected to it. A commonly used technique to debounce signal lines is to periodically check the state of the individual signal lines to determine when the signal states become stable. However, the frequency of the checking of the individual signal lines must be fast enough to ensure that no information is lost. The high polling frequency places a large overhead on hardware used to control the operation of the universal connector.

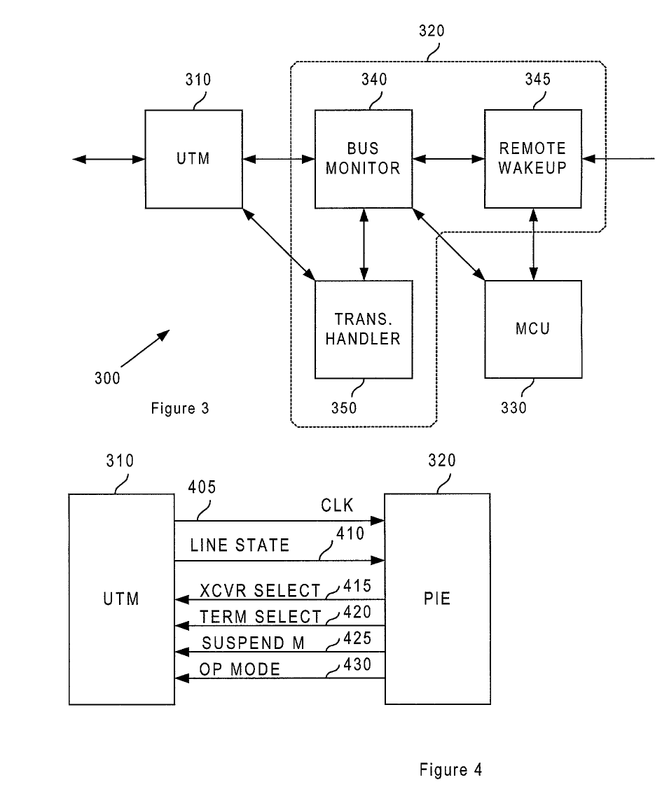

Referring now to FIG. 3, a block diagram displays a universal serial bus (USB) version 2.0 peripheral 300 according to a preferred embodiment of the present invention. The peripheral 300 comprising a USB transceiver macrocell (UTM) 310, a parallel interface engine (PIE) 320, and a microcontroller (MCU) 330. The UTM 310 provides an interface between the PIE 320 and a physical cable connection, in this case, a USB cable. According to the USB version 2.0 technical specifications, the physical layer in the USB version 2.0 is a single data line signal using a differential signaling format wherein two individual conductor lines are used, one referred to as “DP” for data plus and the other as “DM” for data minus.

The UTM 310 handles low-level USB protocol and signaling including: data serialization and deserialization, bit stuffing, and clock recovery and synchronization, with a primary focus on shifting the data's clock to a rate that is compatible with other logic in the peripheral. The rate shifted data stream is then provided to a PIE 320. The PIE 320 performs tasks such as USB process identifier and address recognition, along with other sequencing and state machine functionality to handle USB packets and transactions. Additionally, the PIE 320 may contain functionality that is specific to the peripheral such as peripheral identification number recognition, data/information queues and queue control.

The functionality of the PIE 320 may be partitioned into three distinct components: a bus monitor unit 340, a remote wakeup unit 345, and a transaction handler unit 350. The bus monitor unit 340, coupled to the UTM 310, the remote wakeup unit 345, and the transaction handler unit 350, is used to continually monitor signal lines from the bus. The bus monitor unit 340 monitors a status line referred to as LINE STATE provided by the UTM 310. The UTM 310 derives LINE STATE from the “DP” and “DM” conductor lines and LINE STATE is not the actual signals on the USB cable. The remote wakeup unit 345, coupled to the bus monitor unit 340 and the MCU 330, transmits information to the bus monitor unit 340 to wakeup UTM 310 clock generation function and uses it to wakeup the peripheral 300 that may have gone into sleep mode (also commonly referred to as suspend mode) either automatically after a period of inactivity or when forced to do so by the USB host. The remote wakeup unit 345 may also wakeup the peripheral 300 should some form of user action occur. User action can include the pressing of a key or button or an insertion or ejection of a cartridge or some other form of media. Finally, a transaction handler unit 350, coupled to the UTM 310 and the bus monitor unit 340, handles USB packets, test mode signaling and high speed detection handshake signaling transmitted over the USB.

Coupled to the PIE 320 is the MCU 330. The MCU 330 is similar to a microprocessor or a processing element. In fact, the MCU 330 may contain a microprocessor or a processing element. However, the MCU 330 may contain additional hardware, such as, timers, universal asynchronous receivers/transmitters (UARTS), analog-to-digital converters, digital-to-analog converters, etc. The MCU 330 is a microcontroller of a peripheral while the UTM 310 and the PIE 320 provides the interface to the USB. Examples of the MCU 330 may be a microcontroller of a removable disk drive, a digital camera, a keypad, etc.

According to the USB version 2.0 technical specifications, part of the interface between the UTM 310 and the PIE 320 is a set of interface signals that are used to provide control information between the UTM 310 and the PIE 320. A separate set of data lines (not shown), exists between the UTM 310 and the PIE 320, are used to transmit data in and out of the peripheral 300.

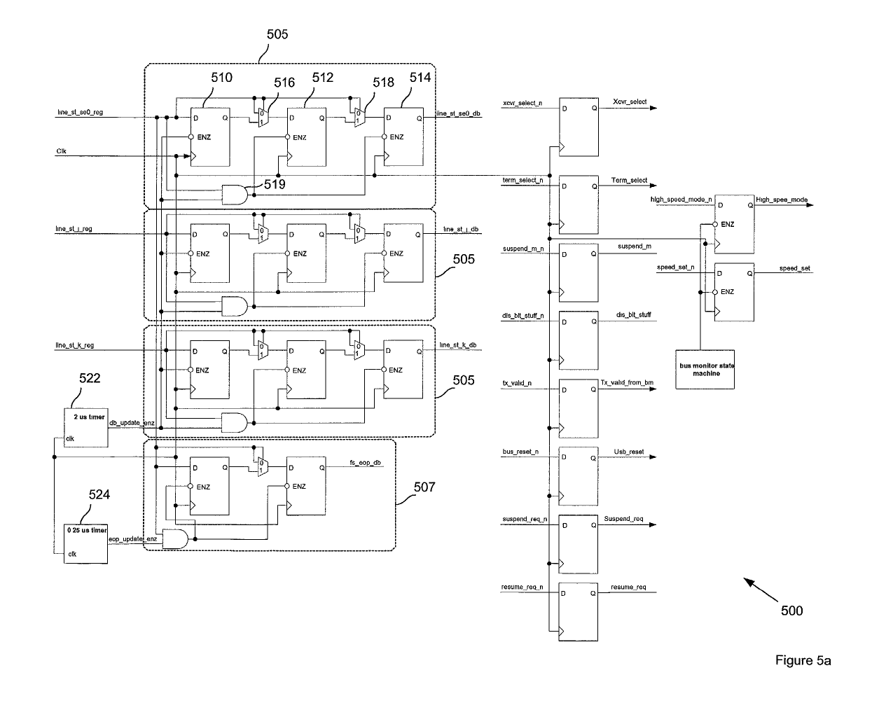

Referring now to FIG. 4, a block diagram illustrates interface signals between the UTM 310 and the PIE 320. A first signal line, from the UTM 310 to the PIE 320, CLK 405, is used to provide clocking information to the PIE 320. A second signal line, from the UTM 310 to the PIE 320, LINE STATE 410, reflects the current state of the single ended receivers and is used by the PIE 320 for detecting USB bus reset, speed signaling, resume signaling, bus idle, and to transition from one behavior to another.

The following signal lines originate at the PIE 320 and goes to the UTM 310. A third signal line, XCVR SELECT 415, is used to select either a full-speed or a high-speed transceiver. A fourth signal line, TERM SELECT 420, is used to select either full-speed or high-speed terminations. A fifth signal line, SUSPEND M 425, places the UTM 310 into a mode that draws minimum power from power supplies and results in the shutdown of all functional blocks not necessary for the wakeup operation. A sixth signal line, OP MODE 430, is used to select between various operating modes, such as normal, non-driving, disable bit stuffing and non-return to zero encoding. A seventh signal line, RESET (not shown) is used to reset all state machines in the UTM 310. A more detailed explanation of the individual signal lines can be found in the USB version 2.0 Transceiver Macrocell Interface specifications.

The signal on the LINE STATE signal line 410 is actually a two-bit value, i.e., the signal can take on up to four different states. The four states being: single ended 0 (SE0), J state, K state, and single ended 1 (SE1). Since the LINE STATE signal line 410 is used for detecting reset, speed signaling, packet timing and to transition between different behaviors, it is an important signal line to check regularly. Therefore, a large amount of overhead is incurred when checking the value of the LINE STATE signal line 410 if conventional periodic polling techniques are used.

Referring now to FIG. 5a, a block diagram illustrates a portion of the bus monitor unit 340 of the PIE 320 responsible for generating debounced signal flag lines for the various states of the LINE STATE signal line 410 according to a preferred embodiment of the present invention. As discussed previously, the two bits of the LINE STATE signal line 410 can represent a total of four distinct states: SE0, J state, K state, and SE1. According to the USB version 2.0 technical standard, state SE1 is reserved for testing purposes and is not used during normal operations. The schematic diagram displays three debouncing circuits 505, each driven by a line representing an output from a data register storing the state on the LINE STATE signal line 410. Notice that there is one debouncing circuit 505 for each usable state of the LINE STATE signal line 410. For example, if the LINE STATE signal line 410 were carrying the state J state, then the data register for the J state would be containing a binary one value while the registers for the SE0 and K states would be containing a binary zero value. Notice that the actual contents of the registers could vary depending on the logical convention used, i.e., logic low true (a zero represents a true value) or logic high true (a one represents a true value).

Referring now to FIG. 5b, a block diagram illustrates the storing of the state of the LINE STATE signal line 410 in data registers according to a preferred embodiment of the present invention. The state of the LINE STATE signal line 410 are stored in register pairs 542, of which, there are three pairs, one for each usable state of the LINE STATE signal line 410. The register pair 542 comprising a cascade of D-type flip-flops 546 and 547, which are clocked by the clock signal as generated by the UTM 310. The cascade of flip-flops 546 and 547 are used to synchronize LINE STATE signal line 410 to the system clock: CLK. Even though LINE STATE signal line 410 is synchronous to the system clock, but due to clock skew, present between UTM 310 and PIE 320, the signal on LINE STATE signal line 410 input to the bus monitor unit 340 may not satisfy the required setup time requirements, so the cascade of flip-flops 546 and 547 are used to synchronize the signal on the LINE STATE signal line 410 with the system clock. In situations when the UTM 310 is implemented as a discrete component and is separate from the PIE 320, the clock skew between the signal on the LINE STATE signal line 410 and the system clock of the PIE 320 can be relatively large.

Inputs to the register pairs are determined by the particular state the register pair is storing. For example, for the register pair storing the SE0 line state, the input to the register pair is the logical NOR 548 of the two binary values of the LINE STATE signal line 410 because the LINE STATE signal line is in state SE0 when the two binary values are both zero. Additional blocks of combinatorial logic 549 and 550 serve a similar function for other register pairs. According to another preferred embodiment of the present invention, other types of flip-flops, such as J-K and T type, are usable as storage devices with the addition of a small amount of glue logic. D-type flip-flops store the binary value at their input when they are clocked and are well understood by persons of ordinary skill in the art of the present invention.

Referring back to FIG. 5a, the debouncing circuit 505 comprising a cascade of three D-type flip-flops 510, 512, and 514 (as discussed previously, other types of flip-flops are usable with the addition of a small amount of glue logic), two multiplexors 516 and 518, and a logical AND gate 519. As discussed previously, input into the debouncing circuit 505 is the output of a data register used to store the state of the LINE STATE signal line 410. The output becomes the input to the first D-type flip-flop 510. The input of the second and third D-type flip-flops 512 and 514 are multiplexed between the output of the previous flip-flop and the output of the storage register with the output of the storage register also being used as the select line for the multiplexor. When the output of the storage register is zero, i.e., when the state of the LINE STATE signal line 410 is not the state driving the particular debouncing circuit 505, the flip-flops in the debouncing circuit 505 are set to zero. When the output of the storage register is one, i.e., when the state of the LINE STATE signal line 410 is the state driving the particular debouncing circuit 505, the input of a flip-flop is the output of the previous flip-flop or the output of the storage register if the flip-flop is the first flip-flop.

Each flip-flop in the debouncing circuit 505 has an enable, used to disable or enable its ability to update its contents. The enable line for the first flip-flop 510 is an active low periodical pulse. A 2-microsecond timer 522 generates an active low pulse for use as a debounce update enable (db_update_enz) every two microseconds. The debouncing circuit 505 will not be able to recognize the state on the LINE STATE signal line 410 if it is not stable for 4 to 6 microseconds. The enables for the two other flip-flops is derived from the debounce update enable combined in a logical AND 519 with the output of storage register used to store the state of the LINE STATE signal line 410 driving the debouncing circuit. If the output of a data register used to store the state of the LINE STATE signal line 410 changes from 1 to 0, it will cause the flip-flops 512 and 514 to update to 0. This particular combination of enable signals prevents the propagation of a particular state of the LINE STATE signal line 410 unless it remains stable for an extended period of time, at least two microseconds.

Notice that due to the particular design of the circuitry, a maximum of only one of the outputs of the debouncing circuits is high (true) and the remaining are low (false) at any given time. The outputs of the debouncing circuits are then usable by other circuitry inside the bus monitor unit 340 and inside the PIE 320 to take proper action based on the state of the LINE STATE signal line 410. The debouncing circuit 505 for LINE STATE signal line 410 can be used to filter out electro-static discharge (ESD) noise introduced during human intervention. ESD noise typically has a pulse width of less than 100 nanoseconds, so 4 to 6 microsecond debouncing time is sufficiently long to provide reliable operation.

A peripheral, whether they use USB-based or use some other type of connector, will often have buttons, switches, keys, etc. that a user may actuate to perform certain functions. Activation of the buttons, switches, and keys will result in a signal being transmitted to the PIE of the peripheral. For example, the peripheral may be a removable storage device and may have buttons to eject the removable media, power the device on and off, etc. The peripheral may also have other signals that it needs to provide back to the PIE. Referring back to the example of the removable storage device, the peripheral may be configured to let the PIE know that the removable media is or is not present.

Typically, the signals generated by the activation of the buttons, switches and keys (signals generated by mechanical means), plus the signals generated by the peripherals themselves (signals generated by non-mechanical means) will require debouncing. Normally, the signals generated by mechanical movement require longer debouncing time than regular electrical signals that may be generated by the devices themselves. As in the case with signals on the communications bus discussed previously, the heretofore commonly used technique for debouncing involves the periodic polling of the signal lines. However, polling involves a great deal of overhead, especially when there are a large number of signal to poll.

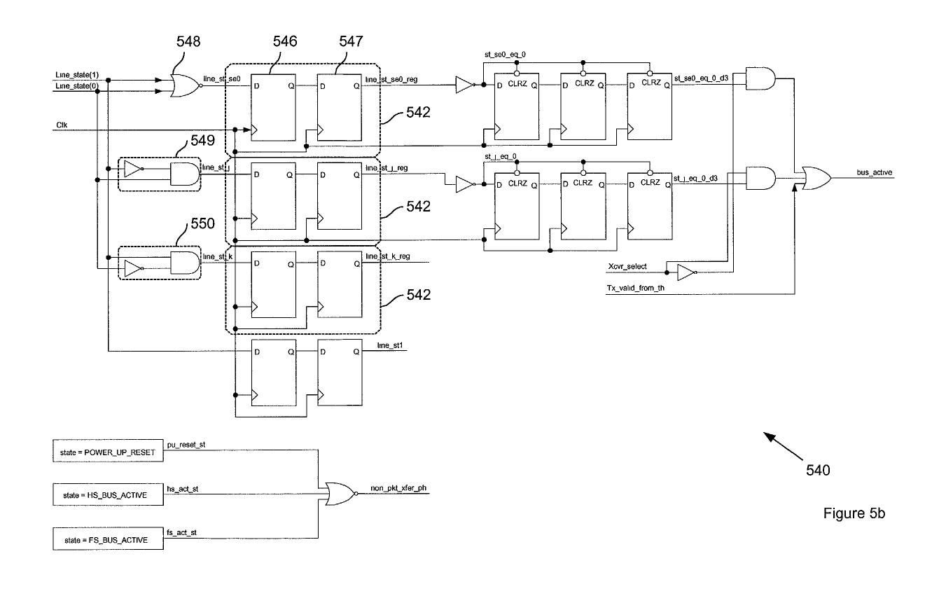

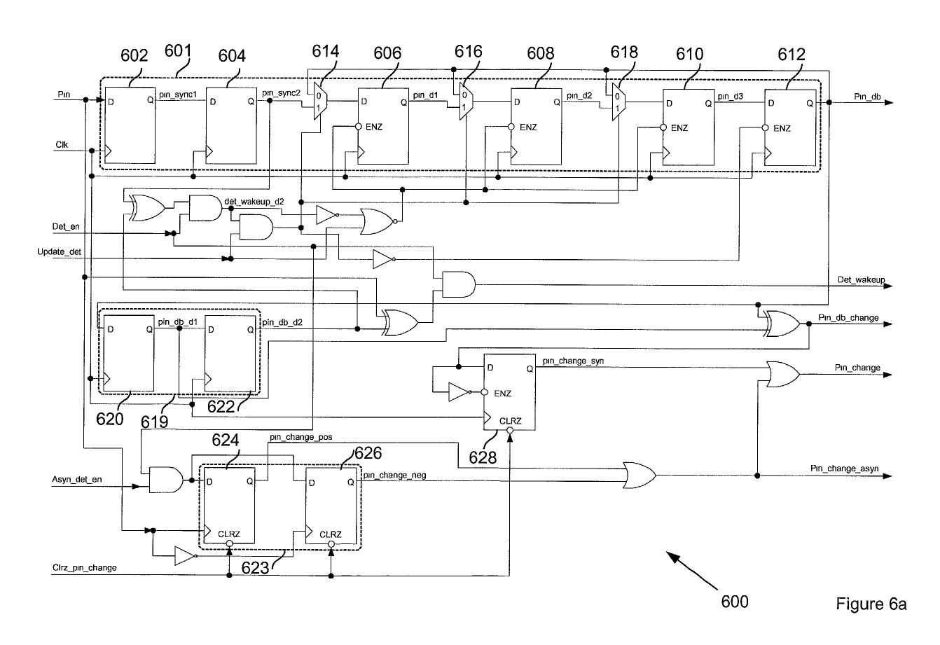

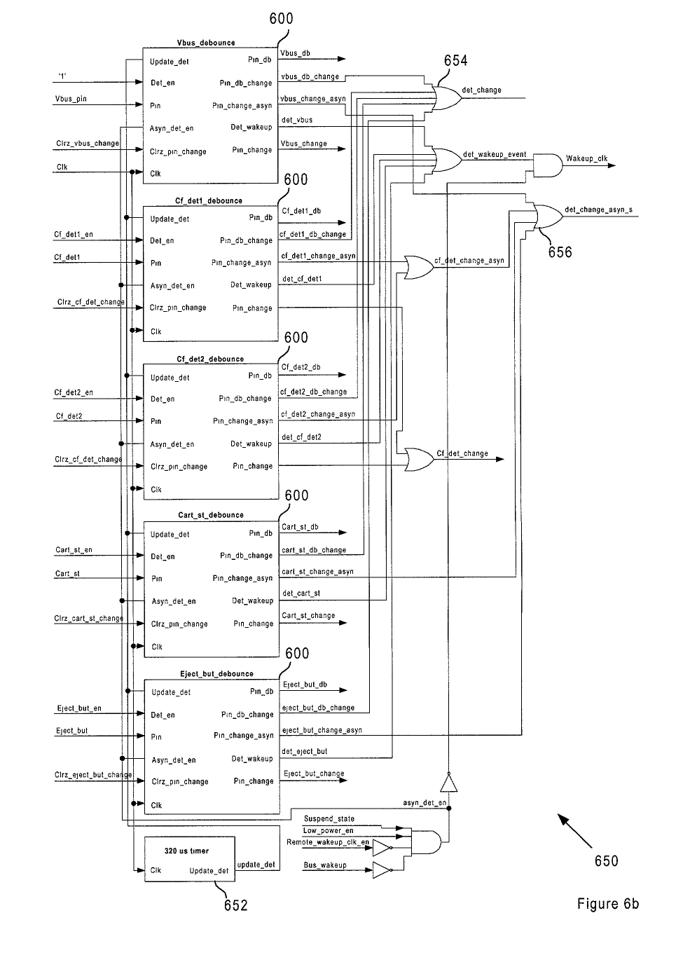

Referring now to FIG. 6a, a block diagram illustrates a debouncing circuit 600 for use in debouncing signals generated by a user actuating a key, switch, or button on the device or by the device itself according to a preferred embodiment of the present invention. According to a preferred embodiment of the present invention, the debouncing circuit 600 is used to provide a debounced and stable signal for any user or device generated control or information signal that is to be provided to the PIE 320. Such a debouncing circuit 600 is typically not used to debounce data being transferred to the PIE 320 to be transferred out of the peripheral.

Similar to the debouncing circuit 505 discussed in FIG. 5a, the debouncing circuit 600 comprises a flip-flop cascade 601 and combinatorial logic. As is the case previously, D-type flip-flops are preferred, although it is possible to use other types of flip-flops with the addition of a small amount of glue logic. According to a preferred embodiment of the present invention, there are a total of six D-type flip-flops in the debouncing circuit flip-flop cascade 601. Input into a first flip-flop 602 is the signal line being debounced. The first flip-flop 602 is clocked by the clock signal generated by the UTM 310. This same clock is also used to clock the remaining five flip-flops in the cascade 601. The output of the first flip-flop 602 is the input into a second flip-flop 604. The first two flip-flops 602 and 604 serve synchronization function (removal of any clock skew) that is similar to the function provided by the data registers 542 from FIG. 5b.

In between the output of the second flip-flop 604 and a third flip-flop 606 is a multiplexor 614, just as there are multiplexors 616 and 618 between flip-flops 606 and 608 and 608 and 610. The output of flip-flop 610 is directly connected to a sixth flip-flop 612, which holds the debounced signal line value. The multiplexors 614, 616, and 618 are to maintain the values in the flip-flops 606, 608, and 610 to be equal to the debounced signal line value (the sixth flip-flop 612) when a pin synchronized value (pin_sync2) is equal to the debounced signal line value (pin_db_d2). Whenever pin synchronized value (pin_sync2) does not last for more than 320 microsecond, the flip-flops 606, 608, and 610 will be reset to previous debounced value (pin_db). The three multiplexors 614, 616, and 618 have a common select line that is the logical AND of an update enable signal referred to as update_det (preferably provided by a 320 microsecond timer that is external to the debouncing circuit 600) and det_wakeup_d2. Det_wakeup_d2 is set to 1 when detection is enabled, i.e., signal Det_en is equal to 1, and the PIN synchronized signal (pin_sync2) is different from the delayed debounced pin signal (pin_db_d2). When det_wakeup_d2 is 1, it permits a new pin value to propagate through flip-flops 606, 608 and 610.

A second flip-flop cascade 619 comprising flip-flops 620 and 622 is used to produce the detect wakeup signal. The detect wakeup signal indicates the presence of a peripheral wakeup signal from the signal pin. Input for the first flip-flop 620 is the output of the sixth flip-flop 612 and the output of the first flip-flop is the input to the second flip-flop 622. The second flip-flop cascade 619 effectively provides a two-clock cycle delay of the output of the first flip-flop cascade 601 and its output is logically XORed with the current value on the signal line being debounced and then logically ANDed with an externally provided detect enable signal to produce the detect wakeup signal: Det_wakeup. Det_wakeup is used to wakeup the UTM clock generation function. When a peripheral is in suspend mode, the system clock is shut down by the UTM to reduce power consumption. When detection is enabled (Det_en is equal to 1) and a pin changes its value, Det_wakeup is used to asynchronously wakeup the UTM clock generation function. When the system clock starts running again, the debouncing logic starts operation. After the debouncing logic updates the pin debounce signal (pin_db), it generate single cycle pulse on the pin debounce changed signal (Pin_db_change) to make the bus monitor unit 340 come out of suspend mode, so the system clock can continue running.

A third flip-flop cascade 623 comprising flip-flops 624 and 626 is used to produce an asynchronous pin change signal. The asynchronous pin change signal is asserted when the state on the debounced signal changes from its previous value and it is used to save the pin change event when the peripheral is in suspend mode and remote wakeup is not enabled. An additional flip-flip 628 produces a pin change signal based on detecting the debounced pin change, differing from the asynchronous pin change signal in that it is in synchrony with the system clock. The output of flip-flop 628 is set to 1 when debouncing circuit detects a synchronous pin change. When the debouncing circuit detects a synchronous pin change, it generates a single cycle pulse on the pin debounce change signal (Pin_db_change) and the flip-flop 628 is used to hold pin synchronous change event.

According to a preferred embodiment of the present invention, the debouncing circuit 600 is used to provide a debounced and stable signal value for every user-actuated pin in the peripheral. Additionally, the debouncing circuit is also used to provide a debounced and stable signal value for control information signal lines provided by the peripheral to the PIE 320. If, for example, the peripheral is a USB removable storage device, such as a cartridge based device with solid-state memory support, a list of signal pins that may use the debouncing circuit can include a Vbus pin, a compact-flash memory (CF) detect pin, a cartridge state pin, and an eject button pin. If there are more than one solid-state memory or cartridge slots, then there would be more CF detect pins, cartridge state pins, and eject button pins.

Referring now to FIG. 6b, a block diagram illustrates a remote wakeup circuit 650 with debouncing circuits 600 for signal pins according to a preferred embodiment of the present invention. According to a preferred embodiment of the present invention, the remote wakeup circuit 650 as displayed in FIG. 6b is for a USB removable storage device with the capability of accepting data cartridges and solid-state memory devices. The remote wakeup circuit 650 can be used with other peripherals with and without minor modifications, depending on the needs of the peripheral, for example, a different number of signal pins, etc. In the removable storage device application, the remote wakeup circuit 650 can be used to detect when a user has inserted or ejected a data cartridge or a solid-state memory device, for example.

For each signal pin required, there is a debouncing circuit 600 (as discussed in FIG. 6a) coupled to the signal pin. As discussed previously, the purpose of the debouncing circuit is to provide a debounced and stable signal and to signal when the signal on the pin changes. Each debouncing circuit 600 has an output referred to as pin_db_change that is asserted when the signal carried on the pin changes. The various pin_db_change outputs are combined in a logical OR operation 654 to produce a global detect change signal (det_change). The global detect change signal signals to the PIE 320 that one of the pins have changed and it needs to take appropriate action. Additionally, det_change is used to generate a wakeup clock request signal (Wakeup_clk_req, not shown) that is used to interrupt the MCU 330 and notify it of an occurrence of a remote wakeup event. Asynchronous pin change detection is used only when remote wakeup is not enabled. It gives a peripheral capability to recognize pin status change after the USB host sends a resume signal to the peripheral.

Due to the independently executing debouncing circuit(s), the control of the peripheral is simple. Rather than having to periodically test each of the signal lines and the communications bus as is commonly done to check for a change of signal or state, the peripheral controller is free to perform its tasks and when a signal line or the communications bus changes state, the independent debouncing circuit asserts a value on a single signal line to signal the controller that a change of signal or state has occurred.

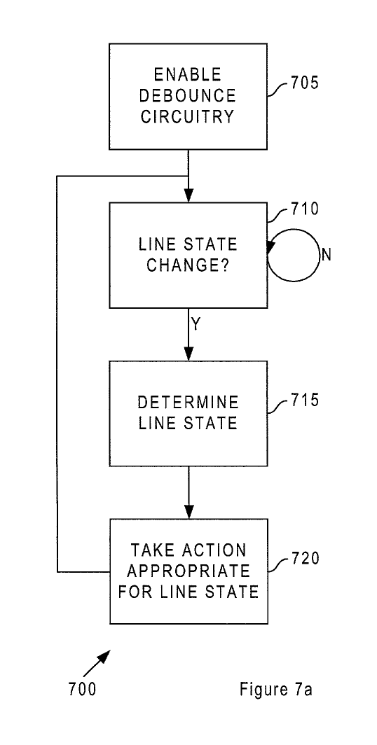

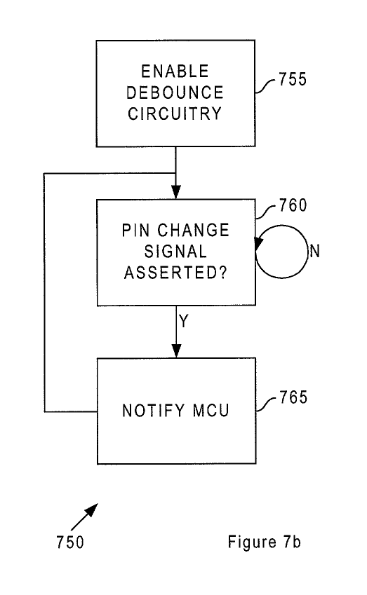

Referring now to FIG. 7a, a flow diagram illustrates an algorithm 700 for processing a change in the LINE STATE signal line according to a preferred embodiment of the present invention. As discussed previously, the LINE STATE signal line is used to denote a change of state in the communications bus of the USB version 2.0 connection system. The algorithm 700 would preferably be executing in a PIE (such as the PIE 320 displayed in FIG. 3) of a peripheral connected on the USB bus.

The PIE 320 begins by enabling the debouncing circuitry (block 705). With the debouncing circuitry enabled, the PIE 320 is free to perform whatever tasks that it does normally and not need to concern itself with polling the communications bus. Whenever a change occurs on the communications bus, the debounce circuitry asserts its bus active signal line and the PIE 320 detects the change to the LINE STATE signal line (block710). The PIE 320 then determines the new state of the communications bus (block 715) and takes appropriate action according to the new state (block 720). Once complete, the PIE 320 returns to its normal operations and the debouncing circuitry continues monitoring the communications bus.

Referring now to FIG. 7b, a flow diagram illustrates an algorithm 750 for processing a change in a signal pin signifying a change in a signal line in a peripheral according to a preferred embodiment of the present invention. As discussed previously, the signal pin lines are used to denote a change in the peripheral of a USB version 2.0 connection system. The algorithm 750 would preferably be executing in a PIE (such as the PIE 320 displayed in FIG. 3) of a peripheral connected on the USB bus.

The PIE 320 begins by enabling the debouncing circuitry (block 755). With the debouncing circuitry enabled, the PIE 320 is free to perform whatever tasks that it does normally and not need to concern itself with polling the signal lines. Whenever a change occurs one (or more) of the signal lines, the debounce circuitry asserts its detected change signal line and the PIE 320 detects the change in the detected change signal line (block 760). The PIE 320 will interrupt the MCU 330 (block 765) and MCU 330 then determines which of the signals lines changed and takes appropriate action according to the signal line. After notifying the MCU 330 (block 765), the PIE 320 returns to its normal operations and the debouncing circuitry continues monitoring the signal lines.

According to a preferred embodiment of the present invention, the debouncing circuitry will assert a change signal line when it detects a change in the communications bus or in a signal line. It is then up to the PIE 320 to detect the change in the debouncing circuit's signal line. The PIE 320 can detect this change by periodically polling the signal line. Since there is only one signal line rather than a large number of individual signal lines or the communications bus, the polling operation does not consume a significant amount of overhead. Alternatively, when the debouncing circuitry detects a change, it can force an interrupt. The interrupt permits the PIE 320 to go about its normal operations without needing to poll the signal line or communications bus. When the debouncing circuitry forces an interrupt, the PIE 320 stops its current operations and processes the interrupt. After processing the interrupt, the PIE 320 can resume normal operations.

After the debouncing circuits provide a debounced and stable signal, other circuitry in the PIE 320 process the signals and perform actions appropriate to the signals that have changed or have been asserted. As discussed previously (FIG. 3), the PIE 320 may be partitioned into three distinct units: the bus monitor 340, the remote wakeup unit 345, and the transaction handler 350. The bus monitor 340 is used to monitor the condition (state) of the communications bus. The conditions include, but are not limited to: bus reset, host resume signaling, bus idle for too long and need to suspend the device and monitor a device detect remote wakeup event. The remote wakeup unit 345 is linked to the bus monitor 340 to provide wakeup signaling to the bus monitor 340. Therefore, it is common to discuss the bus monitor 340 and the remote wakeup unit 345 as one single unit.

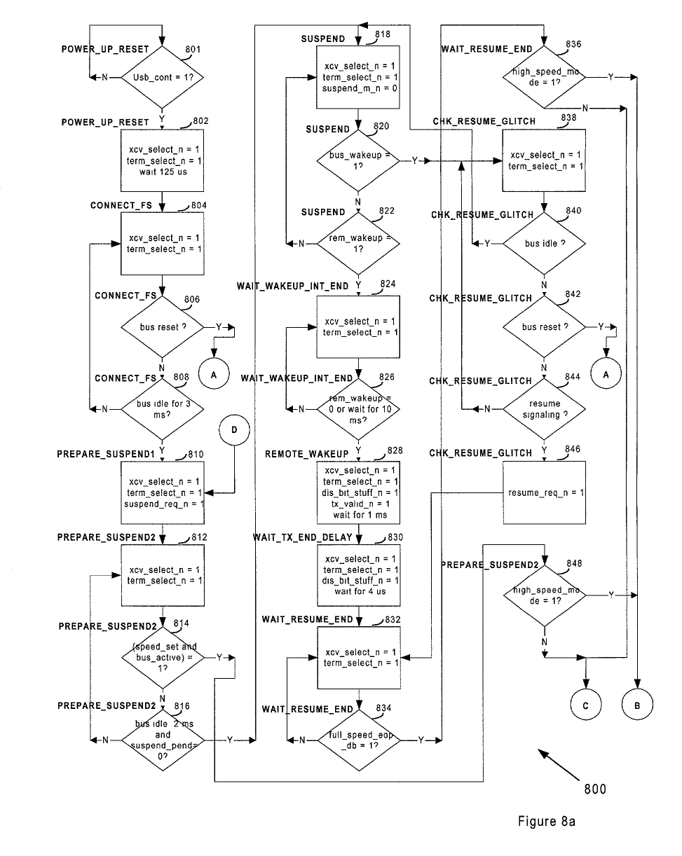

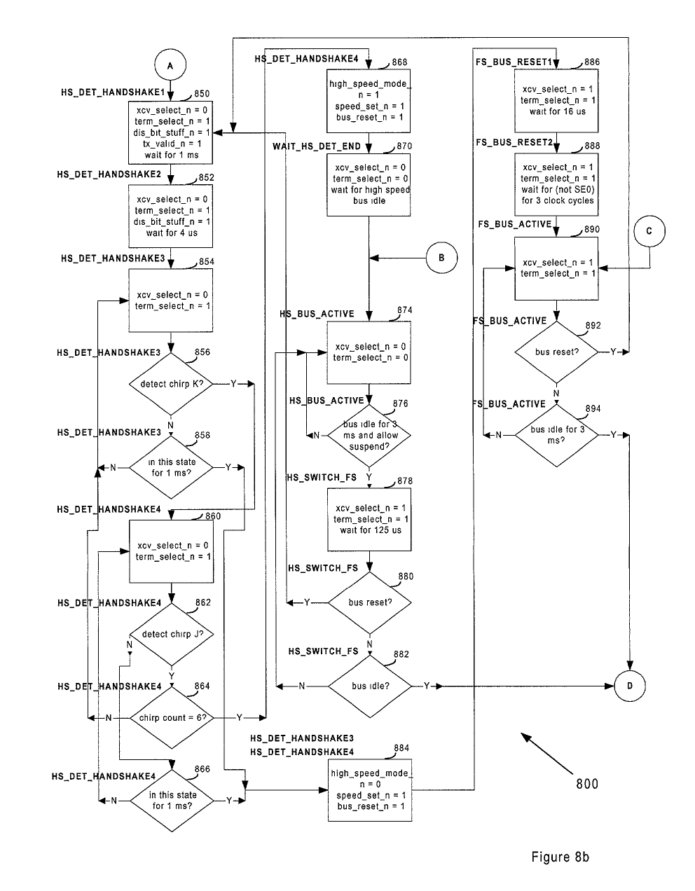

Referring now to FIG. 8a, a flow diagram illustrate a combination flow-chart and state machine 800 for a bus monitor 340 according to a preferred embodiment of the present invention. According to a preferred embodiment of the present invention, the state machine 800 executes in the bus monitor 340 and uses as inputs debounced and stable signals provided to the bus monitor 340 by various debounce circuits, discussed previously. The bus monitor 340, under control of the state machine 800, powers up in an idle state, POWER_UP_RESET (block 801). The bus monitor 340 will remain in the idle state until it receives a signal (Usb_cnt) from the MCU 330 that a peripheral has been connected to the USB and is ready to communicate with host or hub. When the bus monitor 340 is in the POWER_UP_RESET state and the MCU 330 asserts Usb_cnt=1, the bus monitor 340 remains in the POWER_UP_RESET state (block 802) for a preferred time period equal to 125 micro-seconds in full speed mode to permit the signal LINE STATE time to settle.

After waiting for a period of 125 micro-seconds in block 802, the bus monitor 340 enters a CONNECT_FS state and continues its power-up routine by staying in full speed mode (block 804). It is preferred that USB devices initially power-up in full speed mode and then perform necessary handshaking to determine actual connection speed. In block 806, the bus monitor 340 checks to see if a bus reset has occurred. This is performed by checking if the signal (line_st_se0_db) is equal to 1, if it has, then LINE STATE has been continuously SE0 for preferably four to six micro-seconds, meaning that there is a bus reset request from the hub. If a bus reset has occurred, the bus monitor 340 enters state HS_DET_HANDSHAKE1 and jumps to block 850 (FIG. 8b), which will be discussed below.

If a bus reset has not occurred, the bus monitor 340 checks to see if the bus has been idle for three milliseconds (block 808). If the bus has not been idle for three milliseconds, the bus monitor 340 returns to block 804 and waits for a change to occur on the bus. After the peripheral initially connects to the USB, host will send a bus reset prior to the resumption of any normal communications. If the bus has been idle for three milliseconds, the bus monitor 340 enters state PREPARE_SUSPEND1 and sends a suspend interrupt request to the MCU 330 (block 810) if the suspend interrupt is enabled. The bus monitor 340 then enters state PREPARE_SUSPEND2 in full speed mode (block 812) and checks if the bus is active and has completed a first bus reset after power up (block 814).

If the bus is not active or has not completed the first bus reset after power up, then in block 816, the bus monitor 340 checks if the bus is idle for another two milliseconds (for a total idle time of five milliseconds) and the signal (suspend_pend) is equal to zero. If they are not, then the bus monitor 340 returns to block 812. If the bus is idle for another two milliseconds and suspend_pend=0, then the bus monitor 340 enters state SUSPEND and if low power mode is enabled (Low_power_en=1) (block 818), then the UTM clock generation function is disabled and the peripheral will no longer be clocked to save power.

If the bus is active and has completed the first bus reset after power up, the bus monitor 340 jumps to block 848, where the bus monitor 340 checks if high speed mode is enabled, this checks if high speed mode has been enabled prior to entering suspend mode. If high speed mode is enabled, the bus monitor 340 enters state HS_BUS_ACTIVE and jumps to block 874 (FIG. 8b), which will be discussed below. If high speed mode is not enabled, the bus monitor 340 enters state FS_BUS_ACTIVE and jumps to block 890, which will also be discussed below.

Returning to state SUSPEND and block 820, the bus monitor 340 checks if the signal (bus_wakeup) is equal to one. If the bus_wakeup is not equal to one, then the bus monitor checks if the signal (rem_wakeup) is equal to one (block 822). If rem_wakeup is not equal to one, the bus monitor 340 returns to block 818 to wait for a wakeup signal.

If bus_wakeup is equal to one (block 820), then the bus monitor 340 enters state CHK_RESUME_GLITCH and block 838 and checks if a bus reset has occurred or if the host has resumed signaling. In block 840, the bus monitor 340 checks if the bus is idle. If the bus is idle, then the bus monitor 340 returns to the SUSPEND state and block 818. If the bus is idle, then the bus monitor 340 decides that the bus_wakeup was triggered by a glitch in the LINE STATE signal line 410. If the bus is not idle, then the bus monitor 340 checks if a bus reset has occurred (block 842). If a bus reset has occurred, the bus monitor 340 enters state HS_DET_HANDSHAKE1 and jumps to block 850 (FIG. 8b), which will be discussed below.

If a bus reset has not occurred, then in block 844 the bus monitor 340 checks if the host has sent a resume signaling signal (line_st_k_db=1). If line_st_k_db is equal to one, then the bus monitor 340 sends a request to resume interrupt to the MCU 330 (block 846) and enters state WAIT_RESUME_END and jumps to block 832. If line_st_k_db is not equal to one, then the bus monitor 340 returns to block 838 to check the debounced LINE STATE again. According to a preferred embodiment of the present invention, when the bus monitor 340 initially begins checking the bus_idle, bus_reset, and resume signaling signals, the signals themselves are not active. This is because the clock has just started running and signals have not been generated. According to a preferred embodiment of the present invention, the bus monitor 340 will cycle through blocks 838, 840, 842, and 844 for approximately four to six microseconds (an amount of time of sufficient duration to ensure that one of the LINE STATE signals is active). All possible LINE STATE values: bus idle (J state), bus reset (SE0 state), and resume signaling (K state) are checked although one and only one of the three states can be true.

Returning to state SUSPEND and block 822, if rem_wakeup is equal to one, then the bus monitor 340 enters state WAIT_WAKEUP_INT_END and block 824, where it waits for the MCU 330 to finish the remote wakeup interrupt service routing or 10 milliseconds (block 826), whichever is shorter. After the MCU 330 completes the remote wakeup interrupt service routine or 10 milliseconds has passed (block 826), the bus monitor 340 enters state REMOTE_WAKEUP and block 828. The bus monitor 340 sends a resume signal to the host and drives the full speed K state on the bus for one full millisecond.

The bus monitor 340 then enters state WAIT_TX_END_DELAY and block 830 where after driving the full speed K state for one full millisecond, there remains data in the UTM 310 transmission registers. To permit these registers to clear, it is preferred that the bus monitor 340 remain in this state for an additional four micro-seconds, continuing with disabled bit stuffing and NRZI (non-return to zero invert) encoding. Additionally, the bus monitor 340 will maintain operations at full speed (K state) when UTM transmit the remaining data in its transmit registers. According to a preferred embodiment of the present invention, if bit stuffing and NRZI encoding is not disabled, the last bytes in the transmit registers will be transmitted as an alternating J-K-J-K sequence.

The bus monitor 340 then enters state WAIT_RESUME_END and block 832, where the bus monitor 340 waits for the resume to end (when signal full_speed_eop_db=1) (block 834). Once the resume ends, the peripheral returns to its previous speed mode by checking if high_speed_mode=1 (block 836). If high_speed_mode is equal to one, then the bus monitor 340 enters state HS_BUS_ACTIVE and jumps to block 874 (FIG. 8b), which will be discussed below. If high_speed_mode is not equal to one, then the bus monitor 340 enters state FS_BUS_ACTIVE and jumps to block 890 (FIG. 8b), which will be discussed below.

Referring now to FIG. 8b, a flow diagram illustrates a continuation of the flow diagram displayed in FIG. 8a according to a preferred embodiment of the present invention. Turning now to state HS_DET_HANDSHAKE1 and block 850, the bus monitor 340 sets the high speed transceiver select, full speed termination select, disable bit stuffing, and non-return to zero signaling and enables transmission of chirp K for one millisecond. This signals to the host (or hub) that the peripheral is high speed capable. The bus monitor 340 then enters state HS_DET_HANDSHAKE2 and block 852, where it holds the signals set in block 850 for a full four micro-seconds to ensure data in the UTM 310 data registers is transmitted to the bus with bit stuffing disabled and NRZI encoding mode, so host will observe chirp K through the whole duration.

The bus monitor 340 then enters state HS_DET_HANDSHAKE3 and block 854, where it sets high speed transceiver select and full speed termination select. Then in block 856, the bus monitor 340 checks if the host (or hub) has sent the chirp K state to the peripheral by examining the signal (line_st_k_db). If line_st_k_db is not equal to one (host has not sent chirp K state), then the bus monitor 340 checks to see if it has been in the state HS_DET_HANDSHAKE3 for one millisecond (block 858). If the bus monitor 340 has been in the state for one millisecond, then the connected host (or hub) is not high speed capable, so the peripheral has to switch to full speed mode. The bus monitor 340 then jumps to block 884. If the bus monitor 340 has not been in the state HS_DET_HANDSHAKE3 for one millisecond, the peripheral returns to block 854 to wait for the chirp K.

If line_st_k_db is equal to one, then the bus monitor 340 enters state HS_DET_HANDSHAKE4 and jumps to block 860, where it sets high speed transceiver select and full speed termination select. The bus monitor 340 checks if the host (or hub) has sent a chirp J state to the peripheral (block 862) by checking signal (line_st_j_db). If line_st_j_db is equal to one, then the bus monitor 340 checks if it has already received a chirp sequence of K-J-K-J-K-J, i.e., chirp count equal to six (block 864). Notice that the chirp sequence of K-J-K-J-K-J is as specified in the USB UTMI specifications. If the chirp count is not equal to six, the bus monitor 340 returns to state HS_DET_HANDSHAKE3 and jumps to block 854 to continue with the high speed handshaking. If the chirp count is equal to six, then the bus monitor 340 jumps to block 868, where it determines that the host (or hub) is high speed capable, configures the peripheral for high speed mode and waits for the completion of the high speed detection (block 870) by waiting for a high speed bus idle, then goes to state HS_BUS_ACTIVE (block 874).

While in block 868, the bus monitor 340 additionally generates a signal (bus_reset) that is preferably a single cycle in duration. Bus_reset is used to indicate that the peripheral has detected the speed capability (high speed or full speed) of the host (or hub), but that the high speed detection handshake is not yet complete. The bus_reset signal is used to reset USB related logic and will also result in the generation of an interrupt to the MCU 330 if MCU interrupts are enabled. The bus_reset signal results in the resetting of the peripheral's USB address to zero (0) and the re-initialization of the peripheral itself.

Returning to block 862, if line_st_j_db is not equal to one (did not detect chirp J), the bus monitor 340 jumps to block 866 where it checks if it has been in the HS_DET_HANDSHAKE4 state for one millisecond. If it has, then the host (or hub) is not high speed capable and the bus monitor 340 jumps to block 884. If the bus monitor 340 has not been in the HS_DET_HANDSHAKE4 for one millisecond, then the bus monitor 340 returns to block 860 to wait for the chirp J.

Returning to block 874 and the bus monitor 340 in state HS_BUS_ACTIVE, the peripheral is operating in high speed mode and the transaction handler 350 portion of the PIE 320 handles normal USB packet transfers, including token packets, data packets and handshake packets. The bus monitor 340 continues by checking if the bus has been idle for preferably three milliseconds (block 876). If the bus has not been idle for three milliseconds, the bus monitor 340 returns to block 874. If the bus has been idle for three milliseconds, the bus monitor 340 enters state HS_SWITCH_FS and jumps to block 878, where it switches from high speed mode to full speed mode and waits for 125 microseconds to permit LINE STATE signal line 410 time to settle. After entering full speed mode for 125 microseconds, the bus monitor 340 checks if there is a USB bus reset (block 880). This is performed by check signal (line_st_se0_db). If line_st_se0_db is equal to one, then there is a USB bus reset and the bus monitor enters state HS_DET_HANDSHAKE1 and jumps to block 850.

If line_st_se0_db is not equal to one, then the bus monitor 340 checks if the bus is idle (block 882) by checking signal (line_st_j_db). If line_st_j_db is equal to one, then the bus is idle and prepare to enter suspend mode. To enter suspend mode, the bus monitor 340 enters state PREPARE_SUSPEND1 and jumps to block 810 (FIG. 8a). If line_st_j_db is not equal to one, then the peripheral should not be placed into suspend mode and the bus monitor 340 enters state HS_BUS_ACTIVE and jumps to block 874.

Returning to block 884, where the bus monitor 340 may be in either states HS_DET_HANDSHAKE3 or HS_DET_HANDSHAKE4, the bus monitor 340 has determined that the host (or hub) is not high speed capable. The bus monitor 340 has completed the high speed detection handshake phase and now has to configure the peripheral for full speed mode. While in block 884, the bus monitor 340 asserts a pulse preferably of a single cycle in duration on the bus_reset signal. As discussed previously, the bus_reset signal is used to indicate that the peripheral has been able to determine the speed capability of the host (or hub) prior to the completion of the high speed detection handshake. The single cycle pulse on the bus_reset signal results in the resetting of USB related logic, generation of an MCU 330 interrupt (if MCU interrupts are enabled), resetting of the peripheral address to zero (0), and the re-initialization of the peripheral.

In block 886, the bus monitor 340 enters state FS_BUS_RESET1, where it switches from high speed transceiver select to full speed transceiver select and keeps full speed termination select. The bus monitor 340 additionally waits for 16 micro-seconds to allow LINE STATE to become stable prior to checking its state.

The bus monitor 340 enters state FS_BUS_RESET2 and block 888 where it waits for an indication of the end of the USB bus reset, i.e., waiting for LINE STATE to not be SE0 for three clock cycles. After three clock cycles, the bus monitor 340 enters state FS_BUS_ACTIVE and block 890 where it sets full speed transceiver select and full speed termination select. The peripheral is now operating in full speed mode and the transaction handler 350 will handle normal USB packet transfers. The bus monitor 340 continues by monitoring the signal (line_st_se0_db) for a USB bus reset, i.e., line_st_se0_db equal to one for four to six micro-seconds (block 892). If there is a USB bus reset, the bus monitor 340 enters state HS_DET_HANDSHAKE1 and jumps to block 850. If there is not a USB bus reset, then the bus monitor 340 checks if the bus has been idle for three milliseconds (block 894) to determine if the peripheral should be placed in suspend mode. If the bus has been idle for three milliseconds, then the bus monitor 340 enters state PREPARE_SUSPEND1 and jumps to block 810 (FIG. 8a). If the bus has not been idle for three milliseconds, then the bus monitor 340 returns to block 890 and the peripheral continues operating in full speed mode.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for monitoring signal changes on a bus interconnect comprising:
(a) enabling a signal line debouncing circuit;
(b) detecting the assertion of a signal change line;
(c) decoding a debounced signal line; and
(d) performing an operation associated with a signal on the debounced signal line.

2. The method of claim 1, wherein the signal change line is a logical combination of a plurality of debouncing circuit outputs and if any one output of the plurality changes, then the signal change line is asserted.

3. The method of claim 2, wherein if more than one output of the plurality change, then the debounce line is asserted.

4. The method of claim 1, wherein the detecting step comprising the step of periodically polling the status of the signal change line.

5. The method of claim 1, wherein when the signal change line is asserted an interrupt is generated, the detecting step comprising the step of receiving the interrupt and initiating processing of the interrupt.

6. The method of claim 1 further comprising the step of repeating steps (b)-(d) after completing the performing step.

7. The method of claim 1, wherein the assertion is asserted by the signal line debouncing circuit.

8. The method of claim 1, wherein there are a plurality of debounced signal lines, and the decoding step comprises the determination of which debounced signal line changed.

9. The method of claim 1, wherein the signal line debouncing circuit asserts an interrupt when asserting a signal change line, and the detecting step comprises receiving the interrupt.

10. A signal debouncing circuit comprising:
a memory device coupled to a signal line, the memory device to store a value based on a signal value on the signal line;
a serially connected sequence of storage devices coupled to the memory device, wherein:
an input of a first storage device is coupled to the memory device;
an input of subsequent storage devices is selectively coupled to an output of a previous storage device; and
an output of a last storage device provides a debounced version of the signal value provided to the memory device.

11. The signal debouncing circuit of claim 10, wherein the input of subsequent storage devices are selectively coupled to the output of a storage device immediately before it in the sequence of storage devices.

12. The signal debouncing circuit of claim 10, wherein the inputs of the subsequent storage devices are also selectively coupled to the output of the memory device.

13. The signal debouncing circuit of claim 10, further comprising a final storage device coupled to the output of the last storage device in the sequence of storage devices, the final storage device to store the debounced signal.

14. The signal debouncing circuit of claim 13, wherein the inputs of the subsequent storage devices are also selectively coupled to an output of the final storage device.

15. The signal debouncing circuit of claim 13 further comprising:
a previous signal value storage device coupled to the output of the final storage device, the previous signal value storage device to save the signal value for an additional clock period; and
a signal change unit having a first input coupled to the output of a final storage device and a second input coupled to the output of a the previous signal value storage device, the signal change unit to compare its inputs and asserting a signal change flag when the inputs are different.

16. The signal debouncing circuit of claim 10, wherein the memory device comprising two flip-flops sequentially connected.

17. The signal debouncing circuit of claim 16, wherein the flip-flops are D-type flip-flops.

18. The signal debouncing circuit of claim 10, wherein the sequence of storage devices comprising a sequence of flip-flops.

19. The signal debouncing circuit of claim 18, wherein the flip-flops are D-type flip-flops.

20. The signal debouncing circuit of claim 10, wherein the final storage device is a flip-flop.

21. The signal debouncing circuit of claim 10, wherein the signal line is a communications bus to carry a plurality of states, and the signal debouncing circuit further comprising a decoder having an input coupled to the communications bus and an output coupled to the memory storage device, the decoder containing circuitry to decode a state on the communications bus and produce a true output should the decoded state match a desired state.

22. A bus monitor comprising:
a communications bus to carry one of a plurality of states;
a decoder having an input coupled to the communications bus, the decoder containing circuitry to decode a current state of the communications bus;
a plurality of memory storage devices, each memory storage device having an input coupled to the decoder, the memory storage device to store a value provided to it by the decoder;
a plurality of debouncing circuits, each debouncing circuit having an input coupled to one of the plurality of memory storage devices, the debouncing circuit containing circuitry to debounce the value stored in the memory storage device; and
a logic engine coupled to outputs from each debouncing circuit, the logic engine containing circuitry to examine the debounced values and perform prespecified actions based on the debounced values.

23. The bus monitor of claim 22, wherein the decoder produces a true value for a state equal to the current state of the communications bus and a false value for all remaining states.

24. The bus monitor of claim 22, wherein the bus monitor part of a peripheral is coupled to the bus.

25. A peripheral comprising:
a communications bus to permit transmission and reception of data;
a bus interface coupled to the communications bus, the bus interface containing circuitry to translate data on the communications bus into a form usable by the peripheral;
an engine coupled to the bus interface, the engine comprising:
a bus monitor coupled to the bus interface, the bus monitor containing circuitry to decode data from the communications bus and perform prespecified actions based on the decoded data; and
a signal debouncing circuit coupled to signal pins from the peripheral, the signal debouncing circuit containing circuitry to provide a debounced and stable signal from the peripheral to the engine; and
a microcontroller coupled to the engine, the microcontroller containing circuitry to control the operation of the peripheral.

26. The peripheral of claim 25, wherein the communications bus is a universal serial bus communications bus.

27. The peripheral of claim 26, wherein the communications bus is a universal serial bus version 2.0 communications bus.

28. The peripheral of claim 25, wherein the communications bus is an IEEE 1394 communications bus.

29. The peripheral of claim 25, wherein the communications bus is a small computer system interface (SCSI) communications bus.

30. The peripheral of claim 25, wherein the communications bus is a PC card communications bus.
